(19) United States
(12) Patent Application Publication
(10) Pub. No.: US 2025/0008962 A1
(43) Pub. Date: Jan. 9, 2025

(54) MICROBIAL FORMULATION FOR THE PROTECTION OF PLANTS AND AGRICULTURAL CROPS AGAINST ENVIRONMENTAL CONDITIONS AND METHODS OF MANUFACTURE AND USE THEREOF

(71) Applicant: PEWMAN INNOVATION SPA, Santiago (CL)

(72) Inventors: José Manuel PÉREZ DONOSO, Santiago (CL); Denisse Margarita BRAVO RODRÍGUEZ, Santiago (CL); Giovanna Francesca ANZIANI OSTUNI, Santiago (CL)

(73) Assignee: PEWMAN INNOVATION SPA, Santiago (CL)

(21) Appl. No.: 18/016,242

(22) PCT Filed: Jul. 13, 2021
(86) PCT No.: PCT/CL2021/050061

§ 371 Date: Jan. 13, 2023

Related U.S. Application Data
(60) Provisional application No. 63/051,414, filed on Jul. 14, 2020.

(51) Int. Cl. A01N 63/27; A01N 27/00; A01N 31/02; A01N 35/02; A01N 41/12; A01N 55/00; A01P 21/00

(52) U.S. Cl. CPC A01N 63/27; A01N 27/00; A01N 31/02; A01N 35/02; A01N 41/12; A01N 55/00; A01P 21/00

(57) ABSTRACT

An organic formulation based on a mixture of microorganisms and other derived organic components, obtained from plants that inhabit different extreme environments, including the Chilean Antarctic territory, for protecting plants and agricultural crops against environmental conditions, especially with respect to cold stress, water stress, and plant infection by pests and insects, is provided. Due to the activity of the consortia of microorganisms that compose it and its derived components, it favours plant growth and reduces the damage associated with cold and water stress in agricultural crops.

### CROSS-REFERENCE TO RELATED APPLICATIONS

This application is a 35 U.S.C. § 371 National Stage Application of International Application No. PCT/CL2021/050061, filed Jul. 13, 2021, which claims the benefit of U.S. Provisional Application No. 63/051,414 filed on Jul. 14, 2020, the entirety of each of which is incorporated herein by reference.

### SEQUENCE LISTING

The sequence listing presented as an ASCII text filed named “047183-000011_ST25_Sequence_Listing_filed_09-27-2024.txt”, created on Sep. 27, 2024, and consisting of 2,601 bytes is incorporated herein by reference.

### Field

The present invention is a microbial formulation for the protection of crops and plants from environmental conditions, including: cold stress, drought and pests; It is useful in the field of agriculture, research into microbiomes associated with agriculture and the fruit industry, plant biology and the development of sustainable technologies of them.

### BACKGROUND

The consequences of climate change are varied and increasingly significant, with the agricultural sector being one of the most affected sectors.

Due to drought, the world loses 24 billion tons of soil every year and dryland degradation reduces gross domestic product in developing countries by 8% per year (FAO, ISSN 2071-0992).

Currently, there are a series of passive and active measures to mitigate the damage caused by frost, including physical barriers as a protection measure against cold, among which stand out: fixed heaters, mobile heaters, horizontal axis fans, use of helicopters, use of sprinklers, crop protection with fabric/meshes of different weather-resistant materials (UV protection, wind resistance, etc.). However, all these measures are inefficient, expensive, and based on technologies that are unsustainable in the long term, or difficult to access for small and medium-sized producers (FAO, ISSN 2071-0992).

In the state of the art, there are different approaches of the industry to address, for example, cold stress in winter periods or in crops sensitive to sudden changes in temperature, due to sudden changes in environmental conditions. For example, the document U.S. Pat. No. 6,235,683 B1 refers to a method of improving the supercooling of a plant to temperatures below about −2 degrees Celsius, which involves preventing the formation of ice crystals adjacent to the plant by forming a substantially continuous hydrophobic membrane of particles partially in the plant, capable of withstanding water droplets, and where the particulate matter has a size distribution of about 100 um or less, and the substantially continuous hydrophobic membrane has a thickness from about 1 um to about 1,000 um.

On the other hand, in U.S. Pat. No. 6,180,562 B1, compositions are described that, when applied to at least part of the surface of a plant, have utility in protecting the plant from frost by releasing heat in a range of descending ambient temperatures starting at approximately 32° F., and where the compositions contain mainly an aqueous solution of hydrated polymer gel.

In U.S. Pat. No. 7,516,573 B1, a method is proposed to reduce cold damage in a plant, including the steps of: a) applying to plant surfaces a particulate matter in an amount sufficient to form a film of particulate matter sufficient to block at least 20% of solar radiation from reaching the surface of the plant that has the film on it, wherein the particulate matter film comprises selected finely divided hydrophilic particulate matter of calcium carbonate and hydrated kaolin, and the particulate material film allows a gas exchange in the plant; b) expose the plant to a temperature below 15° C. for about 0° C., where said temperature is low enough to cause cold damage to untreated plants, and c) expose the surface of the plant that has the film on it to solar radiation, in which the amount of solar radiation reaching the surface of the plant that has the film on it, its blocked enough that the plant that has the film on it exhibits less cold damage compared to untreated plants that experience similar exposure to temperature followed by exposure to solar radiation.

Alternatively, EP0074718A1 describes a method comprising microorganisms that are acceptable to a host plant, that are deficient in ice nucleation, and that use at least one plant nutrient also used by native ice-nucleating microorganisms, where they are applied to a part of the plant at an early stage of the growth cycle to inhibit the multiplication of native microorganisms that nucleate the ice, so that under normal frost conditions found in the field, frost damage decreases substantially. Non-nucleating microorganisms can be obtained by special selection procedures, selecting between natural microorganisms or mutagenized or recombinant microorganisms, where organisms can also be transformed to provide other desirable properties.

Today, the need for an alternative of organic and sustainable products that efficiently protect crops from damage caused by cold, drought and pests is evident. Although there are available technologies on the market that try to solve this problem such as the use of antimicrobials (copper) or synthetic polymers, these technologies do not address the problem efficiently, either because they do so partially or because their approach is limited, thus reducing their scope, or solving only some of the aspects of this problem, that affects agribusiness globally.

### BRIEF SUMMARY

The invention is a formulation comprising microorganisms of the rhizosphere, among which comprises at least one microorganism without ice nucleating activity (NINA) and at least one biopolymer from the microorganism, capable of reducing the damage caused by the environment, including: freezing and drought, especially preventing the nucleation of ice, where one of the microorganisms of the preferred formulation is a particular proprietary strain called GPI-1 (SEQ ID No 1), belonging to the genus Pseudomonas sp., whose main chromosome presents a similarity >85% with respect to P. fluorescens and also evidences the presence of at least two plasmids. Our formulation corresponds to an organic and natural product, non-polluting, non-toxic and biodegradable, which protects plant and fruit crops from cold and water stress. The production of the present invention is easily scalable, efficiently viable and environmentally sustainable.

In a more detailed description of the invention, the formulation comprises a set of different microorganisms that inhabit plants of extreme environments, including: high mountain terrain, Antarctic territory, and desert territory.

The method of production of the invention can be carried out on a small scale (for example, in a laboratory), as well as on an industrial scale (for example, in bioreactors) where in both cases, the production of the invention can be carried out quickly, at a high yield and at low cost.

### BRIEF DESCRIPTION OF THE SEVERAL VIEWS OF THE DRAWINGS(S)

FIG. 1. Effect of the invention on the protection of plants against cold stress. 1A shows the effect of using the invention and 1B the effect without the invention.

FIG. 2. Effect of the invention on the protection of plants against water stress. 1A shows the effect without the invention and 1B the effect with the invention.

FIG. 3. Effect of the invention on the protection of plants against Insect Infection, after different times of exposure of the invention.

FIG. 4. Root growth stimulation assay in the presence/absence of GPI-1, (A) applying substrate with GPI-1 and (B) volatile compounds derived from GPI-1.

FIG. 5. Production of EPS nanoparticles produced by Pewman PGI-1. Result of the dynamic light scattering (DLS) analysis, using as a substrate the purified EPS of the GPI-1 strain.

FIG. 6. Protective effect of the formulation of the invention, applied in the field.

FIG. 7. Effect of the protection of the formulation of the invention, before a shock of extreme cold in potato cultivation.

FIG. 8. Effect of the protection of the formulation of the invention, in field trials in cherry trees.

FIG. 9. Resistance of GPI-1 to freeze-thaw cycles in the presence or absence of the biopolymer.

FIG. 10. MALDI-TOF of the biopolymer secreted by GPI-1

FIG. 11. Protective effect in plants of the biopolymer secreted by separate GPI-1 (purified biopolymer) and in combination with the microorganism of the invention (CRIOPROTECT).

### DETAILED DESCRIPTION

Characterization of Pewman GPI-1 Bacteria (Strain Isolated and Identified from Extreme Environment)

The sequencing of the GPI-1 genome demonstrates that the strain of the invention does not contain ice-nucleating proteins (INP) or ice binding proteins (PPIs). The absence of INP classifies Pewman GPI-1 as a NINA bacterium and allows for greater tolerance to cold stress while helping to lower the freezing temperature in plant roots and foliage. In this sense, incorporating GPI-1 to the plant also decreases the proportion of INP+ bacteria, and thus decreases one of the main cold damage in tissues associated with ice nucleation previously identified and known in the agricultural industry. (F.J. Bigras and S.J. Colombo (eds.), Conifer Cold Hardiness, (2001), 89-120; Lindow Plant Physiology (1982), 70, 1084-1089).

The Pewman GPI-1 strain grows in glucose, technical glycerol and in crude glycerol, where the generation of biomass is favored in crops using glycerol as the only carbon source, and where the ability of Pewman GPI-1 to grow using crude glycerol as a carbon source decreases the costs of production of biomass and bioproducts derived from this strain.

Additionally, the GPI-1 strain does not show growth with carbon sources of structure similar to Maltodextrin (lactulose, maltotriose, maltose, xylose, etc.). It grows correctly in the presence of molecules associated with the Krebs cycle and amino acids, and in carbon sources that can be selected from the list comprising, but not limited to: arabinose, N-acetyl glucosamine, succinate, galactose, aspartic acid, proline, alanine, trehalose, mannose, glucose-6-phosphate, malate, ribose, rhamnose, fructose, acetate, glucose, thymidine, glutamate, sorbitol, fucose, gluconic acid.

GPI-1, produces organic components of biopolymer type (exopolysaccharide or EPS) and volatile type, including: Dimethyldisulfide, 1-Nonene, 1-Undecanol, 2-Undecanon, 2-Pentane, 3-Methyl-Butanal, Methyldiselenure, 2-Heptane, 2-Nonanona, 1-Undecanol, 2-Undecanone, where both organic components mentioned above have protective capacity in plants and crops, against adverse effects of climate, including drought, freezing and pests.

The EPS produced and secreted by Pewman GPI-1 is a high molecular weight sugar polymer similar to maltodextrin (more than 15 glucose units), and where there would also be some other dextrins in the mixture.

TLC analysis suggests a polysaccharide of approx. 16-19 dextrose equivalents. There is an enrichment in polymers of longer chain (close to 19 equivalents of dextrose) at longer cultivation times.

On the other hand, in the formulation the EPS of GPI-1 is in the form of polymeric nanoparticles (NPs), where these formed NPs presented sizes less than 100 nm, ideal for nanotechnological applications and the decrease of heat transfer on surfaces (such as the surface of leaf tissue).

One application of the invention is its use directly as a plant growth biostimulant, which additionally decreases damage to crops due to water and cold stress. Due to its unique operating mechanism, the invention has a broad-spectrum application effect, being able to act efficiently on any crop, fruits, and vegetables, at different scales of agribusiness, including small, medium and large producers.

In another embodiment of the invention, it corresponds to a mixture of polysaccharides purified from cultures of microorganisms grown from the rhizosphere of plants of Chile, including GPI-1, which allows the control of mites, aphids and whitefly in crops, vegetables and fruits.

In another embodiment of the invention, it corresponds to a mixture of nanoparticles derived from polysaccharides purified from cultures of the selected microorganisms, including GPI-1, which protects different plant crops against cold, water stress and insect infections.

In another embodiment of the invention, the formulation may include a substrate, wherein the substrate may comprise at least one of the following components: microorganisms, metabolites derived from microorganisms, inorganic elements and biomolecules, and any combination thereof, capable of reducing the damage caused by the environment, including: drought and freezing, especially preventing ice nucleation; where this substrate remains for at least 18 months in the plant where it was applied, and induces some modulation in the plant microbiome without negatively affecting the plant microbiome in the long term (positive modulation).

In another embodiment of the invention, the formulation comprises at least one species of bacteria of the genus Pseudomonas capable of resisting environmental problems and conditions such as cold stress, including a bacterium capable of producing a specific compound, which includes a cryoprotective biopolymer, in which the biopolymer can be a carbohydrate and/or a biomolecule composed of carbon, induced in response to a specific environmental condition, including cold stress and any other equivalent environmental condition, that adversely affects the growth and development of plants, crops, fruits and vegetables.

In another application of the invention, it comprises the identification of the microorganism or microorganisms of the formulation, including identification at the genome level, where identification can be made by elements that can be selected from the list comprising: plasmids, specific genes, parts of specific sequences of a gene and any other appropriate section of the genome.

In another application of the invention, the formulation containing bacteria may be effective against pests and/or different insect infections, wherein the formulation containing bacteria, the mechanism of action includes: i) action by contact, causing suffocation by blocking the respiratory spiracles or stigmas of the pest, or ii) action by adhesion, which prevents the mite or insect from adhering to the surface of the plant, The invention can act on a wide spectrum of insects.

Additionally or alternatively, bacteria capable of producing a cryoprotectant biopolymer, which may be part of the formulation of the invention, include (at least one of) the following characteristics:
1. Where the absence of ice nucleating proteins (INP) in the genome of the bacterium increases stress tolerance in the roots and foliage of the plant by reducing the starting point of the freezing temperature. In addition, by adding the bacteria and/or the formulation containing bacteria to the plant, the proportion of bacteria of Ice Nucleating Activity (INA +) is reduced, reducing and/or decreasing the effects of one of the main damages in the tissues due to the action of cold, associated with the nucleation of ice produced during frost;
2. In which the bacterium comprises a unique mechanism of induction, production and secretion for high concentrations of a biopolymer in response to cold stress;
3. Where the bacterium is able to survive cold stress, including the freeze-thaw cycles characteristic of frost, which favor its protective effect during and after frost.
4. Where, due to the characteristics mentioned in 1 to 3, the bacterium is able to prevail or endure in the plant and resist adverse conditions, generating sustained protection over time.
5. Where in addition, the ability of bacteria to produce volatile compounds favors plant growth (mainly the establishment of roots)
6. Where the growth of the bacterium and the production of high concentrations of the polymer can occur using a different set of carbon sources, including glycerol, glucose, any other suitable carbon source and any combination of them, and where one of the main characteristics of the bacterium is that it is able to grow and produce the polymer using crude glycerol (biodiesel residue) as the only carbon source with yields equal to of pure glycerol and superior to those of glucose.

The application of the product is suggested between 1-10 L/Ha depending on the agricultural crop to be protected; It is incorporated into crops by spraying on the leaf tissue and by irrigation on the roots, and with a frequency of between 10-14 days depending on the crop and the season of the year in which it is applied.

The concentration of the biopolymer in the formulation is in the range of 1-100 mg/L; wherein, the present formulation comprises at least one ratio of UFCs of microorganism/ug of biopolymer, unique characteristic of the present invention, and wherein the range of values of the concentration of microorganism comprises 10exp5-10exp8 CFU/ug of biopolymer.

The present invention may be developed or made as a formulation and/or a composition as long as it contains the essential constituent elements described above for the protection of plants with respect to adverse environmental conditions affecting the growth, development and production of crops and plants.

### Cold Resistance: Cold-Shock Proteins (Csp) Family of Transcriptional Regulators.

As part of the characterization of the GPI-1 strain, in particular, it presents 2 copies of the cspA gene, the main transcriptional regulator of DNA binding of cold response, which has been described as initiating a signaling cascade of transcription of different topoisomerases. Experimental evidence in E. coli indicates that cspA transcription is not temperature dependent, however, its mRNA degrades rapidly above 37° C., so its action is cold-dependent. In addition, it has been experimentally demonstrated that the CspA protein acts as RNA chaperone at low temperatures, preventing the formation of secondary RNA structures. A copy of the cspD gene was also found, whose product has no function described beyond a helicase homologous to CspA.

>198P_05228 Major cold shock protein CspA
MATRETGNVKWFNDAKGYGFIQREDGKDVFVHYRAIRGDGHRSLSEGQQ
VEYAVVTGEKGLQAEDVVGL
>198P_05353 Major cold shock protein CspA
MAERQSGTVKWFNDEKGFGFITPESGPDLFVHFRAIQGNGFKSLKEGQK
VTFIAVQGQKGMQADEVQAEG
>198P_04298 Cold shock-like protein CspD
MASGKVKWFNNAKGYGFINEDGKEDDLFAHYSAIQMDGYKTLKAGQPVS
FEIIQGPKGLHAVNIGAPVSLGTAKEDVAQKSEKQSA

### Water Stress: RpoS and DskA (DksA)

In general, drought response pathways are not specifically studied, since all factors identified to date as drought tolerance in bacteria correspond to tolerance factors to general abiotic stress. However, a 2018 study determined 2 factors as critical for specific tolerance to water stress: Dsk y RpoS. (A network of regulators promotes dehydration tolerance in Escherichia coli—PubMed—https://pubmed.ncbi.nlm.nih.gov/29457688)

RpoS is a general stressor and is present with 1 copy in the genome of our bacterium and with 4 transcriptional regulators. On the other hand, DksA is an RNA-polymerase binding protein, and our bacteria have 3 copies of that gene. Additionally, the bacterium has a copy of DksD, a protein described as homologous to DksA.

>198P_05240 RNA polymerase sigma factor RpoS
MALSKEAPEFDIDDEVLLMETGIATESMSNEGPAVPSVRTKSKNSTALKQHKYIDYTRAL
DATQLYLNEIGFSPLLTPEEEVFFARLSQKGDPAGRKRMIESNLRLVVKIARRYVNRGLS
LLDLIEEGNLGLIRAVEKFDPERGFRFSTYATWWIRQTIERAIMNQTRTIRLPIHVVKEL
NVYLRAARELTQKLDHEPSPEEIANLLEKPVGEVKRMLGLNERVSSVDVSLGPDSDKTLL
DTLTDDRPTDPCELLQDDDLSQSIDQWLSELTDKQREVVIRRFGLRGHESSTLEDVGLEI
GLTRERVRQIQVEGLKRLREILEKNGLSSESLFQ
>198P_00382 Regulator of RpoS
MTAVDLPAVPRVLIAEADPWSRDLLKQVLLNVRCDARLDVCADGQQAAELLRDKPYDLII
ADWELPGVDGLSLLHSVRQQRRSPLLPFILLGTRNDSASVHEVLPLAPTAYLTKPLNMES
LTQRLQDLLLNEGETVYCEVPALAPGMTLPVFLERRREASDGAPLRVDVQAAVQYSLEPE
GLDLKRLEEQVRMDPQITAVLIAAANSAGHHGSPVQTLAMALHKLAAGQSMNLILGLALK
HNVVLSDPSLKDYAERYWQLSQRTADYARSLARMLDLDHERCYSAGILHRLGDLALLRCL
QDWLQGGGELDDEAIGESLYTFGAAYGSALRTRWRLPLELRQLIAAIYSLEGGVYSREAL
VVNLAAQLARLTEHEGVEALAKSKTARLLKVGLPELARMRKV
>198P_00843 Regulator of RpoS
MNKLTSEVKVLVVDDQPLIVEELCEFLESNGYRCVPCNSSQQAIERFRDDTEIGLVLCDL
HMPEMDGIELVQALQRLAGKQRVFEAIMLTGRADKQDVIKALRAGIADYYQKPINLGELL
EGLQRQVVALQDRQKNLDLGHLNQKLQFLSASIDDLYHDLDKVRSSPQTVQSNEADGEVS
DTDRVEIPAIFNQLSPRQLDVARLVGKGQTNYQIACELGITENTVKLYVSQVLRLTHMHN
RTQLALALSPNNSPARQRVTAH
>198P_01240 Regulator of RpoS
MAQPSILVLEDDEIIRSLMVDVLEDFGAVVTSFPSADEGMIFLERTSDPVDLIVSDIQMP
GLLNGYDLSKVVAHRWPSLPVLLTSGNTAMASQLGSTVRFLPKPWSAERLLDCVQSALLK
GPPLH
>198P_02056 Regulator of RpoS
MQKTSATLLIIDDDEVVRASLAAYLEDSGFSVLQASNGLQGLQVFERDKPDLVICDLRMP
QVGGLELIRQVTDLSPQTPVIVVSGAGVMNDAVEALRLGAADYLIKPLEDLAVLEHSVRR
ALDRARLLLENQRYREKLETANRELEASLNLLQEDQNAGRQVQMNMLPVSPWSIDEFKFA
HQIIPSLYLSGDFVDYFRVDERRVAFYLADVSGHGASSAFVTVLLKFMTTRLLFESKRNG
TLPEFTPSQVLGHINRGLISCKLGKHVTMVGGVIDEETGLLTYSIGGHLPLPVLYTPDSV
RYLEGRGLPVGLFNEATYEDHILELPPTFSLTLMSDGILDLLPEPTLKEKEAALPQRVRS
AGGSLDGLRQVFGLATLGEMPDDIALLVLSRNL
>198P_00128 RNA polymerase-binding transcription factor DksA
MTEQDLLAQPLADYMNEAQQGFFRELLLAQRNELQVRIDAEFMVLREQEPNSDPADVGSA
EEQRQWQLRLLEREKKLLDKIDEALEHLARGEYGWCRETGEPIGLKRLLLRPTATLCIEA
KEREELRERHQRAI
>198P_00997 RNA polymerase-binding transcription factor DksA
MPTQAKQQSISGFQPYVESKGEEYMGKPMREHFSKILKQWKQDLMQEVDRTVDHMKDEAA
NFPDPADRASQEEEFALELRARDRERKLIKKIDKTLQLIEDEEYGWCESCGVEIGIRRLE
ARPTADLCVDCKTLAEIKEKQVGK
>198P_03656 RNA polymerase-binding transcription factor DksA
MTKEKLLAMPADDYMNAEQHAFFEQLLQDMKVEHHERIEQNRIAIESLDTPADPADAASV
EEERTWLVNAIDRDQRMLPQLEQALGRIKEDSFGWCDDSGEPIGLKRLLISPTTKYCIEA
QERHEQIDKHQRQA
>198P_04298 Cold shock-like protein CspD
MASGKVKWFNNAKGYGFINEDGKEDDLFAHYSAIQMDGYKTLKAGQPVSFEIIQGPKGLH
AVNIGAPVSLGTAKEDVAQKSEKQSA

It is important to mention that the GPI-1 isolate strain does not present IBP genes, which means that it does not produce ice-binding proteins, thus minimizing crystal formation.

Below are some PPI genes not present in the previously isolated, identified and characterized strain:

>sp|H7FWB6|IBP_FLAFP Ice-binding protein OS = Flavobacterium frigoris
(strain PS1) REV
MKILKRIPVLAVLLVGLMTNCSNDSDSSSLSVANSTYETTALNSQKSSTDQPNSGSKSGQTL
DLVNLGVAANFAILSKTGITDVYKSAITGDVGASPITGAAILLKCDEVTGTIFSVDAAGPACKIT
DASRLTTAVGDMQIAYDNAAGRLNPDFLNLGAGTIGGKTLTPGLYKWTSTLNIPTDITISGSS
TDVWIFQVAGNLNMSSAVRITLAGGAQAKNIFWQTAGAVTLGSTSHFEGNILSQTGINMKTA
ASINGRMMAQTAVTLQMNTVTIPQ
>sp|A5XB26|IBP_COLSX Ice-binding protein OS = Colwellia sp. REV
MKTLISNSKKVLIPLIMGSIFAGNVMAAGPYAVELGEAGTFTILSKSGITDVYPSTVTGNVGTS
PITGAALLLNCDEVTGAMYTVDSAGPLPCSINSPYLLELAVSDMGIAYNDAAGRVPADHTELG
TGEIGGLTLEPGVYKWSSDVNISTDVTFNGTMDDVWIMQISGNLNQANAKRVTLTGGALAK
NIFWQVAGYTALGTYASFEGIVLSKTLISVNTGTTVNGRLLAQTAVTLQKNTINAPTEQYEEAP
L
>tr|B3GGB1|B3GGB1_FLAB3 Ice-binding protein OS = Flavobacteriaceae bacterium
(strain 3519-10)
MNKFLLLAASVAFMSFSGKAHAQAPTLGAAANFALFTTAGAVTNTGLSHITGDVGTNNAAST
NFGNVDGVMQDSNGATSAAAADLLIAYNLLNAAIPTATLAPLLGNGTTLTAGNYFIGQGASLS
GTLTLDGGGNSNSVFIFKIQGALSSAANTQVLLTNGALACNVFWKVEGLVDLATNTVMKGNV
VANNAAIVLQSGVSLEGRALSTTGAITVTGVTVRKPILCGSAVLTGPVAPNLGTVVCYTIFSGN
GALTNAGITYVTGDVGTNVGLTTGFQADNVNGTIHSNPDTSTAQAALDLNNAYTYLNTLPTDI
ELLYPAAFGQNLVLTPHTYLLNAATVLNGKVTLDAQGNENAVFVIKINGALSTTVNASVELING
AIAKNVFWKVDGAVDLNDYTKFKGSVIGNNGAVIINTGVEIEGRVLSTSGGISTFGINAQMTP
GCELLGTGSNTVAIQAAKFYPNPFSSVLNVTMEDLNGGSTLTIYNAAGSQVFSKVLSTKTTSL
SMKLPAGVYFYQMIGKNGAKQAGKLIAKP
>tr|A0A654DWA0|A0A654DWA0_9BACT Ice-binding protein (Modular protein)
OS = Marinoscillum sp. 108
MKIIKSGLVLALLPILMFVGCDKDKDPVLVSPDVVSTAPADDATGIAVTAAVQFNFLADMNPET
LNSTTVVLMEGTNKVATTVSYANKKLTMTPVANLKNSTVYTATVKTGAESELGAALENDFTITF
TTVAEVDNEVPVISSTSPLANAVNITKGNSVSIVFNEPMNPATINVTTFTLVKGTTAVAGVVSY
ADNTATFTATESFESNTAYTARITTGAQDLAGNGLAADTEWSFTTTDFAAPFINSTAPLSDAT
GVARNKTVSVVFNEPMNPATISAATFQLKNGTTSVPGVVAYSGTTATFTSTTILEASTVYTAQI
TTGAQDLSGNGLANNESWSFTTGEVTATLAMVNLGGASNYVILAKTAINNSSTSAITGHLGL
SPAATSYITGLDLVDATGYATSSQVTGNVYAADMADPTPVNLTTAVNDMITAYNDAAGRPTPE
FLELGTGNIGGMTLSAGLYKWTSTVTIPADVTLTGAADDVWIFQISGDLTQSSAINMTLNGGA
QAKNIFWQVAGEATFGANSHFEGNILSMTGITFLTGASINGRALAQTAVILDANAVTKVQ
>tr|K419X5|K419X5_PSYTT Secreted ice-binding cell surface protein
OS = Psychroflexus torquis (strain ATCC 700755/ACAM 623)
MKNSLFTTAIISFLISFVSLEASVINSNTKGNIVNTTSISHMLVPEMMILPVFDTNPVLSNTRLS
SVETSCANQLVADLIASHAELWGLTSTASHGAAFVNETLSPGVYDVITAATISGTLTLDAGGD
PNALFVIRVVGALSTAVNTTVGLTGNARPENIFWVANGAISTGAGTTMKGTLIGGPPGDAAVS
LGANTNHVGRMFTLGGAVTSGATGTILIIPTGTSVINLKSLSTFAMWSNLGAIATGADSNTTG
DIGTFAGAISFGANSIHNGTVYSPGSDFCALIPTVWIGEVSTVAENISNWTNGFPDRDIDVLIN
ITPNDPIFSENLEMKNLVIAIGASVSQTNESQIDIYGDLENNGTYNPGNSTLAFKGDGIQNFST
DNTISVYNLTIDNDNSLNLLSGNVDIFNSLNLTTGDLITNYDHTIPDNNLVTFKSNATHTAIISE
IKNSNTVHGEVMIERYITMQNRAFRFMTTSVNTTTSINENWQEGVNNTVNDYTQNKNPNPGY
GTHITGSTTGVNGLDSTPTGNPSLFSWDSQNESWLTISNTNINTLVAGKAYGILIRGDRDTNI
YSNNLVMGGDTRLRSLGTILTGDVNMDNDLNPNSEGFALIGNPYQAEVDMKATLANSSTHLD
KRFYYAYKPSIGERGGYVTVDLDSEPVEHIPEVPLNNNMDSEKFRFLQVNQSVFVQTVSDLQP
NEVPTLTFKEEFKTDDTSTSQVLRVNSNSKIDLNIFSNSNNELMDGVRFKFDATYDEEAGPDD
ALKFWNDDETIGIHSDGNYLAIEKRPFPKDEDVFSFWIGNYRDLDYTMNVEVEDMPDYDIFLR
DTYTEVDHQLNEGENDIAFSIDSSIPASVNSDRFKIRFEQITLGTSQNEMVASSQLYPNPSNS
GFAYLKHNPDFNNELKVSVFNIIGQNIEIPKDLLSSSELKLNTSSLNSGIYLVKLTYQTQTTTHK
LIIE
>tr|K4I9B1|K4I9B1_PSYTT Secreted ice-binding cell surface protein
OS = Psychroflexus torquis (strain ATCC 700755/ACAM 623)
MTIDNSHSLNLVSGNVDVFNSLNLTTGDLITNYDHSIPGNNLVTFKSNATNTAIISKIENGNTV
HGEVMIERYITMQNRAFRFITTSVNTTTSINENWQEGVNNTVNDYTENKDPNPGYGTHITGST
TGVNGLDATPTGNPSLFSWDSQNGSWLTISNTNTNTLEAGKAYGILIRGDRGTNMYLNNLAK
GDDTRLRSLGTILTGDVNIDNDLNPNSEGFALIGNPYQAEVDMKATLKNSSTHLDKRFYYAYK
SSIGDRGGYVTVDLDSEPVEHIPEVPLNNNMGPEKFRFLQVNQSVFVQTDENLOSNEVPSLTF
KEEFKTDQTSTNEVLRVNSNSKIDLNIFSISNEKLMDGVRFKFDTAYDEEAGPDDALKFWND
NETIGIQSDGKCLAIEKRPFPKDEDVFSFWIGNYRDADYTMNVEVEGMPDYNIFLRDTYTEVD
HQLNEGENDIAFSIDSSIPASVNSDRFKIRFEQITLGTSKNEMTASSQLYPNPSNSGFAYLKHN
PDFNNELKVSVFNMVGQNIEIPKDRMSSSELKLNTSSLNSGIYLVKLTYQTQTTTHKLIVE
>tr|K4IDA2|K4IDA2_PSYTT Ice-binding/adhesin-like protein OS = Psychroflexus
torquis (strain ATCC 700755/ACAM 623)
MKTIILSIAIIAYSFSSIAQDEQPPIDIYLGTAANFILFTGAGAVANTGVSEITGDVGSHAGAIAG
FGLPTVLNGTIQNTNSITAQALLDLAAACVQLQNIPATITDHSGIFGSLEGETIYPGVYSNAAAV
SLTGTLTLDAQGDPDAMFIFKITGALNSVAGATVLLANGASSENVYWIAVGALALGANTTMKG
TAIAYPGAVSLGAGASIDGSLYSTVGAIAINSTVGTKPTYNTPFGCDINAYLFQDNDVYTIDLA
SGSSYEIATDITTGDINATGYNPVDGYIWGSLSSPEKTIVRVGKNFNTTSYYIDELPSSDTKIG
DVSADGIYYLKGEDTTYYKIDLNPSSADFAQHQSTESLSQNISIDDWAFNAVDGNLYAIEKIS
NILYRIDPSDGNVQTMGEVPILSGSTYTYDAVYFDVDGRFYISASEIGTIFVVQDVQDLDGSN
AIDSNLFAFGPSSSNSDGARCPTALVAQEICDNGIDDDGDGLIDCEDPSCSGYGSCPIIESNT
SGGNDGGLESNNRLSDKISQRNYNRAKINYRFDRGVARRVSKSSNYAKRSPNSNFQLQNFIP
LTVIDEDYVIDSTPIDLLGITNAVDVYSV
>tr|K4INU9|K4INU9_PSYTT Secreted ice-binding cell surface protein
OS = Psychroflexus torquis (strain ATCC 700755/ACAM 623)
MNNLRFTTTIISFIISLASLEASVINSITEGDIVTNNPTHNVSVSEMTIFPVSGTDPVLSNAELSS
SETFCATQAAADLITLYNELIAYPGGVTHPLVFGNGEILSPGVYDVGGAPSISGTLTMDGDGDP
NSLFIIRGPGAFTTVAGTTVVLTGNAQPENIFWVSGAAMSTGASTIMKGTLVGGGGGAGAVS
LGANTNHVGRMFTKLGAVSVGASSILAIPTGTPFFNLRSLSTFVMWSSGGALSDSASSDITG
DVGTASGALAIAGTHNGRIYFPGVDYCALNPTVWTGDISTDAENVNNWTKGLPDRDIDVLINI
SVNYPTFSEDVEMKNLSIATGAIVSQTNESQIDVYGDFQNNGTYNPGNSTLAFKGDEIQNFST
NNTISVYNLTIDNDNSLNLLSGNVDVFNSLNLTTGDLITNYDHTIPGNNLVTFKSSATNTAIISE
IKNSNTVVGEVMIERYIPMRNRAFRFMTTSVTTTTSIKDNWQEGVNNTVNDYEQNLNPNTGY
GTHITGSTTGDNGFDATFTGNPSLFEWESQNGSWSTISNTNENTLEAGKAYGILLRGDRNTN
IYSNNSVVGGDTRLRSLGTILTGDMNIDDDLNPNSEGFALIGNPYQAEVDMKATLANSSTHLG
KRFYYAYKPNIGDRGGYVTVDLDSEPVEYIPEVSSNNNTNSEKFRFLQVNQAVFVKTDENLQP
NEVPSLTFKEEFKTDQTSTNEVFRVNSNSKIDLNIFSISNNELMDGVRFKFDTTYDEEAGPDD
ALKFWNDDETIGIQSDGKYLAIEKRPFPKDEDVFSFWIGNYRDADYIMNVEVENMPDYDVFLR
DTYTEEDHQLNEGENDIAFSIDSSIPASVNSDRFKIRFEQITLGTSKNEMTASSQLYPNPSNSG
FAYLKHNPDFNNELKVSVFNMVGQNIEIPKDRISSSELKLNTSSLNSGIYLVKLTYQTQTTTHK
LIVE
>tr|K419X0|K419X0_PSYTT Secreted ice-binding cell surface protein
OS = Psychroflexus torquis (strain ATCC 700755/ACAM 623)
MKTIILSIAIIAYSFSSIARDEQSPIDIYLGTAADFILFTGAEAIANTGISDITGDVGSHVGAIAG
YGPPTILDGTIQNTNSITAQALLVLASGSSYEIATDISTRNINAAGYNLVDGDIWGSFSSPEMK
VLPVSDTNPVLSNIELSSSETFCATQATADLITLYNELIAYPGGVTHPLVFGNGEVLSPGVYDIG
GAQSISGTLTMDGGGDPNSLFIIRGPGAFTTVAGSTVVLTGNAKPENIFWVSSAAMSTGASTI
MKGTLVGGGGGAGAVSLGANTNHVGRMFTKLGAVSVGASSILAIPTGTPFFNLRSLSTFVMW
SSGGALSDSASSDITGDVGTASGALAIAGTHNGAVYHPGIDYCALNPTIWIGEVSTVAENINN
WTKGFPNRDIDVVINITPNDPIFSENIEIQNLSIATGASVSQANESQIDVYGDFQNNGTYNPG
NSTLAFKGDEIQNFSTNNTISVYNLTIDNDNSLNLLSGNVDVFNSLNLTTGDLITNYDHTIPGN
NLVTFKSSATNTAIISEIKNSNTVVGEVMIERYIPMRNRAFRFMTTSVTTTTSIKDNWQEGVN
NTVNDYEQNLNPNTGYGTHITGSTTGDNGFDATFTGNPSLFEWESQNGSWSTILNTDTNTLE
AGKAYGILIRGDRATNIYVNNNSRGGDTNLRSLGIILTGDVNIDADLNPNPDGFSLIGNPYQA
EVDMKKTLANSSKHLDKKFYYAYRPNLGTRGGFVAVDLNANPVEGVPNDPTDENTIAAKFRYL
QVNQSVYVQTDQNIQPTQVPLLTFKEKFKTDQSSTNVVFRDVPTSKVDLNIFSNSNNKLMDG
VRFKFDATYDEEAGTDDALKFWNDDETIGIQSDGNYLAIEKRPFPKDEDIFSFWIGNYRDIDYI
MNVEVESMSDYVIFLKDTYTEVDHQLNEGENDIAFSIDSSVPASINSDRFKIQFEKTTLGTSQ
NEMAGSSQIYPNPSNSGFAYLLHNPDFNSELKVSVFNILGQSIAIPKDRLSSSELKLNTSSLNS
GIYLIKLTYQTQTTTHKLIIE
>sp|Q086E4|IBP1_SHEFN Ice-binding protein 1 OS = Shewanella frigidimarina
(strain NCIMB 400)
MNHSIKKTYLVFTMLLGFILLAGCNGDNNNDNSNNDNNGVLLTSIAVTPATPSMPLGLKQQFT
AMGTYSDGTSSDITNSATWSSDDSTVATINGSGLAMGVIPGSVAITASLIDSSSNEQSATTTL
TITDATLTALAITPVNPSLAKGLTKQFMATGTYSDGTSPDVTTSVTWSSANTLVATVNASGLA
SGVAIGSSIITASLGSDETTTELNITDAILSSIALTPVEPSIAKGITQQFTAIGTYSDGISVDITAS
SNWSSADTLVATMNTSGAAKGVSIGSSIITADFQAQSATSLLTVTDASLTSIMLTPANPHIPK
GNTLQLTATGIYSDGISVDITSSAIWSSADTLIATVNADGVVSGITSGSAIITATSAALSATTTV
TVTDTTLTSIAVTPGNQTIVKGSNKQLTATGTYSDGSLANITASVTWSSADTLVATVNNSGLA
SGIETGSSLISASSGALSGSTNLTITGAALNSIVVSPTNLSLVKGMNKQFAATATYSDGSVADI
STSVTWSSADTLVATIDVNGLANGKAAGSSLITATSGAQSNSTNLTVTDATLNSIDVTPINPSI
IKNSSQNFVATGHYSDGSTTNITSTVMWSSADTLVATLNPNEQLNSGRATAIEVGSSVIQASL
SGVFADTTLNVTAALPNNPLAPELGEVARFAMLASQAITTTSGSAIVDGDLGILDQARSYYAGF
TPGVNAGEFDELTNGLSYAGDDSTPPYVVPVPYASMVAFINQSRTDLGIAYNFLAADPNPNAA
TQVCPIELGNLTLTRGVYKTAADVTLQTGTLTLDGEGDPDSVFIFTIGGNLTSGAPGGDIVLIN
GAQAKNIYWRTAGKTVIGTNTNFSGNVFAWSEVNVRTGANVTGRLFAVTDQVTLDANAVTK
AN

### EXAMPLES

The present invention (microbial formulation) has been tested both in the laboratory and in the field. The laboratory test showed that it favors the growth of plants such as Arabidopsis thaliana, and also reduces the damage caused by low temperatures. On the other hand, field experiments demonstrated that the invention has an obvious protective effect against cold and water stress in avocados treated with the current invention.

As an example of the invention and its use in different environmental conditions, we describe below a set of examples with respect to different types of environmental conditions tested, as follows:

### Example 1. Effect of the Invention on the Protection of Plants against Cold Stress

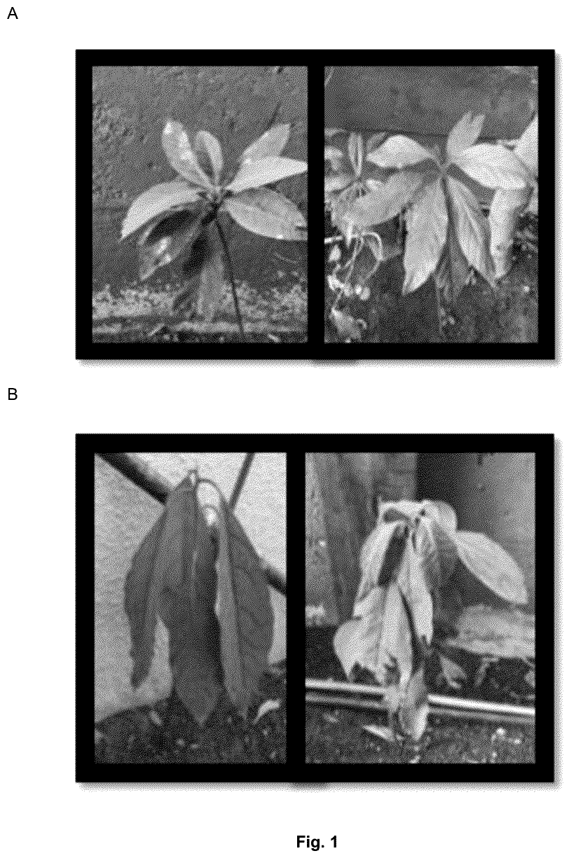

FIG. 1 shows the effect of the invention applied in avocado trees, subjected to frost for 10 days (with average temperatures of −2° C. at night). A) Avocados treated with the formulation of the invention and B) Untreated avocados, both subjected to the same conditions of soil, light, irrigation and temperature.

### Example 2. Effect of the Invention on the Protection of Plants against Water Stress

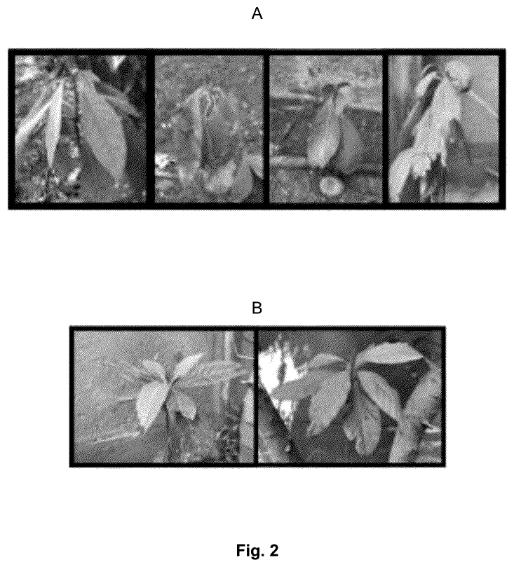

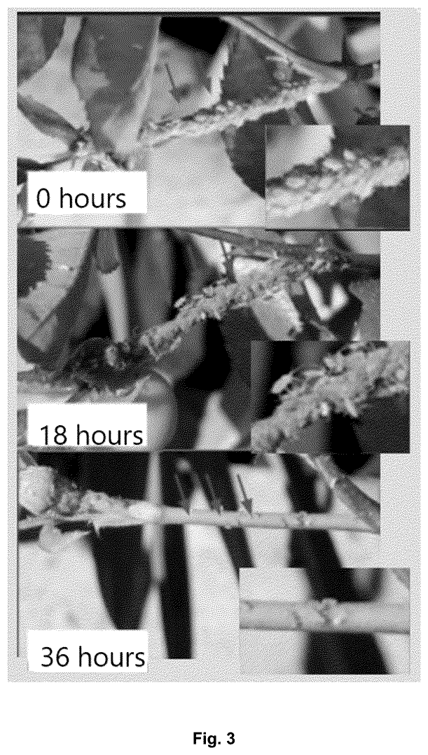

FIG. 2, shows the effect of the invention on avocados subjected to water stress for 9 days. Untreated avocados (A) and treated with the formulation of the invention (Crioprotect) B) subjected to the same conditions of soil, light, temperature and absence of irrigation (drought).

### Example 3. Pewman GPI-1 Promotes Plant Growth by Stimulating Lateral Root Growth

Trials in Arabidopsis thaliana have shown that the addition of GPI-1 to the substrate of the plant favors the formation and growth of lateral roots. This same result was obtained by exposing A. thaliana seedlings to volatile compounds generated by GPI-1. (FIG. 4)
1. Root growth stimulation assay by supplementing the substrate with GPI-1.
2. Root growth stimulation assay when exposing seedlings to volatile compounds generated by GPI-1.

### Example 4. Example of Formulation of the Invention

Our formulation contains between 10⁵ to 10⁸ CFU/ml of total bacteria, where the formulation also contains: an aqueous solubilizer that contains amino acids, minerals, glycerol as a stabilizer and biopolymers, where at least one of these biopolymers is produced directly by one of the microorganisms of the formulation.

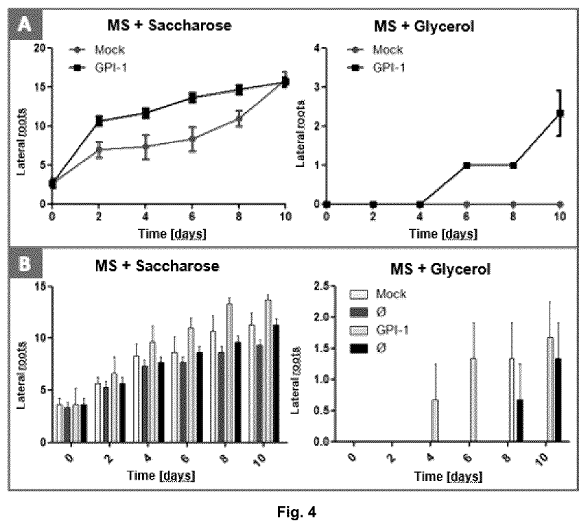

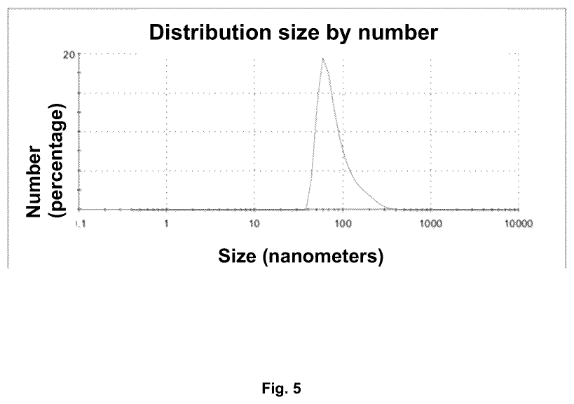

Under the growth conditions of the bacteria used in the formulation, these bacteria are able to form and secrete biopolymers at the nanometric level (FIG. 5), essential to generate better protection against cold stress.

### Example 5. Protective Effect of the Formulation

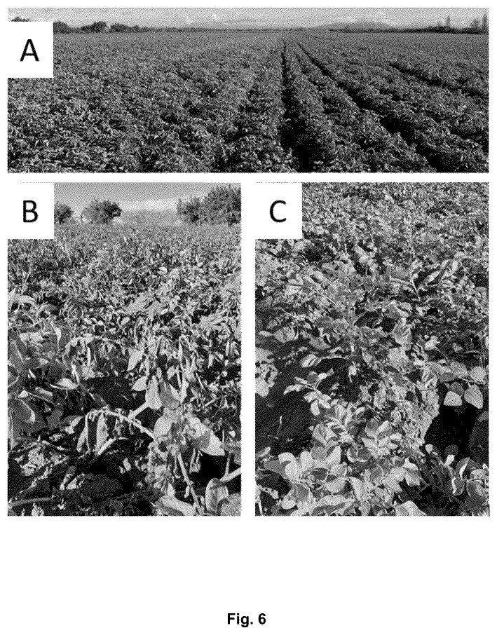

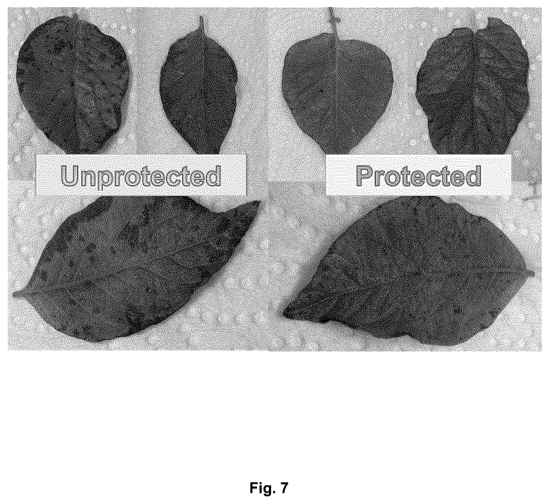

A) A panoramic view of the division between the unprotected sector (left) and the protected sector (right) is shown where a clear discoloration is observed in the unprotected sector (FIG. 6).
B) Plants in the unprotected sector have dry, damaged and yellow leaves, apart from completely dead plants being observed (FIG. 6).
C) Plants in the protected sector visibly healthier, more vigorous and without dead plants (FIG. 6).

### Example 6. Protection against a Cold Shock in Potato Cultivation

Se muestra el resultado correspondiente a plantas con y sin tratamiento de la formulación de la invención, que estaban en el campo. Las plantas fueron luego expuestas a un shock de frío a −15° C. por 5 min y posteriormente, se evaluó el daño (FIGURA 7).

### Ejemplo 7. Protección ante un shock de frío en Cerezos

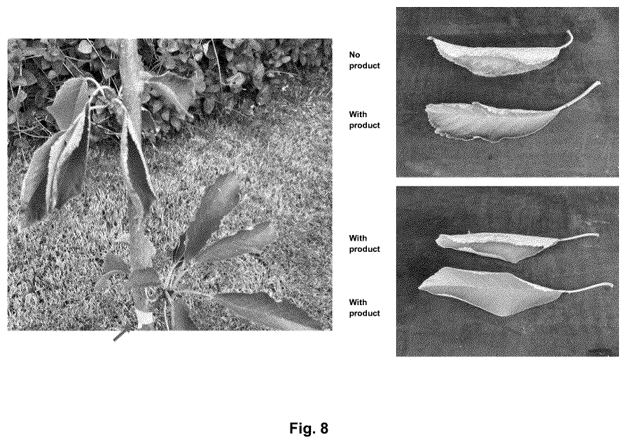

Leaves extracted directly from plants in treated and untreated field trials with the formulation are shown and exposed to environmental frosts. A difference is observed in the size and number of necrosis points on the upper surface of the leaves (FIG. 8).

### Example 8. The Biopolymer Produced by Pewman GPI-1 Promotes Tolerance to Freeze-Thaw Cycles

GPI-1 in the presence of the biopolymer survives a greater number of freezing cycles than when it is growing without the biopolymer. The effect of the biopolymer on the bacterium by producing and secreting the biopolymer was evaluated, and also by adding the purified biopolymer to GPI-1 cultures (two concentrations of biopolymer, 1 and 1.5 X) (FIG. 9).

### Example 9. The Biopolymer Produced and Secreted by Pewman PGI-1 is a High Molecular Weight Sugar Polymer

El Biopolimero EPS sintetizado por GPI-1 fue analizado por espectroscopia de masas (MALDI-TOF). Los resultados coinciden mayormente con la mayoría de los peaks encontrados en estándar de maltodextrina comercial, confirmando que corresponde a un polimero de dextroza con algunas modificaciones (cuya producción y secreción no ha sido descrita a la fecha en bacterias) (FIGURA 10).

### Example 10—Adding Biopolymer or CRIOPROTECT to Plants Decreases Damage from Leaf Freezing (FIG. 11)

### Example 11—Characterization of Bioactive Volatile Compounds Produced by Pewman GPI-1

TABLE 2
Organic volatile compounds produced by GPI-1 in LB media.

| Tiempo | | | | | Área |
|---|---|---|---|---|---|
| Retención | Compuesto | Match | R. Match | Probabilidad | (%) |
| 3.37 | Dimetildisulfuro | 813 | 899 | 93.6 | 3.35 |
| 7.36 | 1-Noneno | 915 | 918 | 26.2 | 0.21 |
| 13.74 | 1-Undecanol | 898 | 903 | 6.64 | 89.78 |
| 18.88 | 2-Undecanona | 922 | 929 | 90.6 | 6.66 |

### Example 12—Characterization of Volatile Compounds Generated by GPI-1, Performed by GC-MS

TABLA 3
Organic volatile compounds produced
by GPI-1 in LB media supplemented.

| Tiempo | | | | | Área |
|---|---|---|---|---|---|
| Retención | Compuesto | Match | R. Match | Probabilidad | (%) |
| 2.58 | 2-Pentano | 856 | 865 | 72.6 | 0.31 |
| 3.44 | 3-Metil-Butanal | 676 | 847 | 34.6 | 0.4 |
| 6.53 | Metildiselenuro | 844 | 846 | 97.3 | 1.16 |
| 6.90 | 2-Heptano | 883 | 898 | 82.1 | 1.05 |
| 13.3 | 2-Nonanona | 934 | 935 | 89.2 | 39.96 |
| 13.81 | 1-Undecanol | 890 | 900 | 6.49 | 50.62 |
| 18.90 | 2-Undecanona | 899 | 900 | 88.7 | 6.49 |

List of Sequences

Seq ID No. 1

| | |
|---|---|
| <210> | 1 |
| <211> | 1532 |
| <212> | DNA |
| <213> | GPI-1 (Cepa aislada) |
| <220> | |
| <221> | 16S |
| <400> | 1 |

| | |
|---|---|
| TGAAG AGTTT GATCA TGGCT CAGAT TGAAC GCTGG CGGCA GGCCT AACAC ATGCA AGTCG | 60 |
| AGCGG TAGAG AGAAG CTTGC TTCTC TTGAG AGCGG CGGAC GGGTG AGTAA TGCCT AGGAA | 120 |
| TCTGC CTGGT AGTGG GGGAT AACGT TCGGA AACGG ACGCT AATAC CGCAT ACGTC CTACG | 180 |
| GGAGA AAGCA GGGGA CCTTC GGGCC TTGCG CTATC AGATG AGCCT AGGTC GGATT AGCTA | 240 |
| GTTGG TGGGG TAATG GCTCA CCAAG GCGAC GATCC GTAAC TGGTC TGAGA GGATG ATCAG | 300 |
| TCACA CTGGA ACTGA GACAC GGTCC AGACT CCTAC GGGAG GCAGC AGTGG GGAAT ATTGG | 360 |
| ACAAT GGGCG AAAGC CTGAT CCAGC CATGC CGCGT GTGTG AAGAA GGTCT TOGGA TTGTA | 420 |
| AAGCA CTTTA AGTTG GGAGG AAGGG CAGTA AATTA ATACT TTGCT GTTTT GACGT TACCG | 480 |
| ACAGA ATAAG CACCG GCTAA CTCTG TGCCA GCAGC CGCGG TAATA CAGAG GGTGC AAGCG | 540 |
| TTAAT CGGAA TTACT GGGCG TAAAG CGCGC GTAGG TGGTT CGTTA AGTTG GATGT GAAAT | 600 |
| CCCCG GGCTC AACCT GGGAA CTGCA TTCAA AACTG ACGAG CTAGA GTATG GTAGA GGGTG | 660 |
| GTGGA ATTTC CTGTG TAGCG GTGAA ATGCG TAGAT ATAGG AAGGA ACACC AGTGG CGAAG | 720 |
| GCGAC CACCT GGACT GATAC TGACA CTGAG GTGCG AAAGC GTGGG GAGCA AACAG GATTA | 780 |
| GATAC CCTGG TAGTC CACGC CGTAA ACGAT GTCAA CTAGC CGTTG GGAGC CTTGA GCTCT | 840 |
| TAGTG GCGCA GCTAA CGCAT TAAGT TGACC GCCTG GGGAG TACGG CCGCA AGGTT AAAAC | 900 |
| TCAAA TGAAT TGACG GGGGC CCGCA CAAGC GGTGG AGCAT GTGGT TTAAT TCGAA GCAAC | 960 |
| GCGAA GAACC TTACC AGGCC TTGAC ATCCA ATGAA CTTTC TAGAG ATAGA TTGGT GCCTT | 1020 |
| CGGGA ACATT GAGAC AGGTG CTGCA TGGCT GTCGT CAGCT CGTGT CGTGA GATGT TGGGT | 1080 |
| TAAGT CCCGT AACGA GCGCA ACCCT TGTCC TTAGT TACCA GCACG TAATG GTGGG CACTC | 1140 |
| TAAGG AGACT GCCGG TGACA AACCG GAGGA AGGTG GGGAT GACGT CAAGT CATCA TGGCC | 1200 |
| CTTAC GGCCT GGGCT ACACA CGTGC TACAA TGGTC GGTAC AGAGG GTTGC CAAGC CGCGA | 1260 |
| GGTGG AGCTA ATCCC AGAAA ACCGA TCGTA GTCCG GATCG CAGTC TGCAA CTCGA CTGCG | 1320 |
| TGAAG TCGGA ATCGC TAGTA ATCGC GAATC AGAAT GTCGC GGTGA ATACG TTCCC GGGCC | 1380 |
| TTGTA CACAC CGCCC GTCAC ACCAT GGGAG TGGGT TGCAC CAGAA GTAGC TAGTC TAACC | 1440 |
| TTCGG GAGGA CGGTT ACCAC GGTGT GATTC ATGAC TGGGG TGAAG TCGTA ACAAG GTAGC | 1500 |
| CGTAG GGGAA CCTGC GGCTG GATCA CCTCC TT | 1532 |

1. A formulation for the protection of agricultural plants and crops against unfavorable environmental conditions for their growth comprising:
a. a microorganism without ice-nucleating activity (NINA) isolated from rhizosphere of plants inhabiting different extreme environments, including the Antarctic territory, capable of growing in the presence of carbohydrates and/or carbon-based substrate, and is resistant to environmental stress, including water stress, cold stress, wherein the microorganism: belongs to the genus Pseudomonas including the GPI-1 strain, lacks nucleating activity of ice and IBP genes, and where the microorganism also comprises a unique mechanism of induction, production and secretion of a biopolymer in response to stressful situations, including cold stress, and where in addition, the microorganism grows very well in economically and environmentally sustainable carbon sources, including: glucose, technical glycerol, crude glycerol, and any other carbon source derived from biodiesel industry waste;
b. an organic component derived from the micro-organism, including at least: a biopolymer, a mixture of volatile components and any combination thereof;
c. a means of solubilizing the micro-organism and the organic component derived from the micro-organism; and
d. a stabilizer.

2. The formulation of claim 1, wherein the formulation contains at least one concentration of the biopolymer in the range of 1-100 mg/L of formulation, wherein in said range there is also a relationship between the microorganisms and the biopolymer of the invention, between 10⁵ to 10⁸ of CFU/ug of biopolymer.

3. The formulation of claim 1, wherein the microorganism corresponds to a new species of the genus Pseudomonas.

4. The formulation of claim 3, wherein the microorganism is the isolated and identified strain GPI-1 (SEQ ID No 1), and wherein said strain comprises a unique mechanism of induction, production and secretion for high concentrations of at least one biopolymer and at least one volatile substance, both protective products in response to environmental stress, including cold stress.

5. The formulation of claim 4, wherein the selected microorganism grows very well in economically and environmentally sustainable carbon sources, including: glucose, technical glycerol, crude glycerol, and any other carbon source derived from biodiesel industry waste.

6. The formulation of claim 5, wherein the microorganism presents differentiated growth using carbon sources, wherein said organism does not present growth when carbon sources of structure similar to maltodextrin are used, including but not limited to:
lactulose, maltotriose, maltose, xylose; and where, if it presents growth when using carbon sources of the list that includes: arabinose, N-acetyl glucosamine, succinate, galactose, aspartic acid, proline, alanine, trehalose, mannose, glucose-6-phosphate, malate, ribose, rhamnose, fructose, acetate, glucose, glucose, thymidine, glutamate, sorbitol, fucose, gluconic acid.

7. The formulation of claim 6, wherein in addition, the microorganism grows correctly in the presence of molecules associated with Krebs cycle and amino acids.

8. The formulation of claim 7, wherein the microorganism secretes an exopolysaccharide (EPS) in the presence of glycerol and proportional to the amount of glycerol present in the medium.

9. The formulation of claim 1, wherein the organic component is a biopolymer produced and secreted from the microorganism of the formulation, wherein there is a relationship between the amount of microorganisms and biopolymers of at least between 10⁵ to 10⁸ CFU/ug of biopolymer, and where the concentration of the biopolymer in the formulation is in the range of 1 to 100 mg/L.

10. The formulation of claim 11, wherein said biopolymer corresponds to a sugar polymer of high molecular weight similar to maltodextrin, with cryoprotective capacity in microorganisms and multicellular organisms, including bacteria and plants.

11. The formulation of claim 1, wherein the organic component are nanoparticles made from the biopolymer secreted by the microorganism of the formulation, wherein the size of said nanoparticles is in the range of 50 to 500 nm.

12. The formulation of claim 1, wherein the organic component is a volatile organic substance produced or derived from at least one microorganism of the invention with protective capacity for plants, with respect to adverse environmental conditions, including: water stress, low temperatures, freezing and pests.

13. The formulation of claim 12, wherein the volatile organic substance can be chosen from the list comprising: Dimethyldisulfide, 1-Nonene, 1-Undecanol, 2-Undecanon, 2-Pentane, 3-Methyl-Butanal, Methyldiselenuro, 2-Heptane, 2-Nonanona, 1-Undecanol, 2-Undecanone, any other volatile substance produced by a microorganism of the formulation and combinations thereof.

14. The formulation of claim 1, wherein the formulation comprises at least two components: i) the microorganism, ii) the organic component; where the microorganism corresponds to GPI-1 which is a strain that is of the genus Pseudomonas that produces an EPS that corresponds to a sugar polymer of high molecular weight of more than 15 glucose units, similar to maltodextrin, and where the organic component corresponds to the EPS secreted by GPI-1, and where said formulation generates cryoprotection and biostimulation in plants.

15. The formulation of claim 1, wherein the formulation comprises at least two organic components, which may be selected from the list comprising: EPS derived from the microorganism, nanoparticles derived from EPS derived from the microorganism, volatile substances derived from the microorganism, and any combination thereof.

16. The formulation of claim 1, wherein the formulation protects the plant, crop, fruit, or vegetable where it is applied, for a sustained period, including maintaining its protective activity on the given target for up to 18 months.

17. A method for the protection of agricultural plants and crops against unfavorable environmental conditions for their growth using a product which includes the formulation of claim 1, the method comprising:
a. Preparation of the product,
b. Initial application of the product,
c. Repeating the application of the product, with a frequency of between 10-14 days depending on the crop and the season of the year in which it is applied.

18. The method of claim 17, wherein the preparation of the product comprises the preparation of the formulation containing at least:
(i) a micro-organism without ice-nucleating activity (NINA) identified from plants inhabiting different extreme environments, including the Antarctic territory, capable of growing in the presence of carbohydrates and/or carbon-based substrate, and is resistant to environmental stress, including water stress, cold stress;
(ii) an organic component derived from the microorganism;
(iii) a means of solubilizing the micro-organism and the organic component derived from the micro-organism; and
(iv) a stabilizer.

19. The method of claim 18, wherein the initial application of the product comprises between 1 to 10 L/Ha depending on the agricultural crop to be protected.

20. The method of claim 19, wherein the application of the product in crops can be: a) by spraying on the leaf tissue, and b) by irrigation directly on the roots.

21. The formulation of claim 1, where the bacterium is resistant to environmental stress and in which the bacterium can produce a biopolymer and volatile substances

22. The formulation of claim 1, wherein the formulation has a mechanism of action including i) action by contact, causing asphyxiation by blocking the respiratory spiracles or stigmas of the pest, and ii) action by adhesion, which prevents the mite or insect from adhering to the surface of the plant, thus the formulation can act on a wide spectrum of insects.

23. A composition for the protection of agricultural plants and crops against unfavorable environmental conditions for their growth, wherein the composition comprises:
a. a micro-organism without ice-nucleating activity (NINA) isolated and identified from plants inhabiting different extreme environments, including the Antarctic territory, capable of growing in the presence of carbohydrates and/or carbon-based substrate, and is resistant to environmental stress, including water stress, cold stress; wherein the microorganism can be selected from the list comprising: microorganisms of the rhizosphere resistant to extreme conditions without ice nucleating activity and without IBP genes, NINA bacteria, recombinant microorganisms without ice nucleating activity, isolated strains of NINA bacteria, strains of Pseudomonas NINA, including the GPI-1 strain (SEQ ID No 1) and any other microorganism without ice-nucleating activity isolated from a rhizosphere sample of plants of different species, including environment under extreme conditions, and where the selected microorganism can grow on economically and environmentally sustainable carbon sources, including: glucose, technical glycerol and crude glycerol.
b. an organic component derived from the micro-organism; where said organic component includes at least one of the following: a biopolymer and a volatile substance, both protective to environmental stress, including cold stress; wherein the biopolymer produced and secreted in the presence of glycerol and proportional to the amount of glycerol present in the medium from the microorganism of the formulation, corresponds to a sugar polymer of high molecular weight similar to maltodextrin, with cryoprotective capacity in microorganisms and multicellular organisms, including bacteria and plants; and where the volatile substance has protective capacity for plants, with respect to adverse environmental conditions, including: water stress, low temperatures, freezing and pests, where said volatile substance is a stimulator of root growth and where in addition, said volatile substance corresponds to a mixture of volatile substances and where said mixture contains at least two of the elements of the list comprising: Dimethyldisulfide, 1-Nonene, 1-Undecanol, 2-Undecanon, 2-Pentane, 3-Methyl-Butanal, Methyldiselenide, 2-Heptane, 2-Nonanona, 1-Undecanol, 2-Undecanon, any other volatile substance produced by a microorganism of the composition and combinations thereof.
c. a means of solubilizing the micro-organism and the organic component derived from the micro-organism; and
d. a stabilizer.

24. The composition of claim 23, wherein the microorganism is GPI-1 and is found in the formulation in a concentration of between 10⁶ and 10⁷ CFU/mL.

25. The composition of claim 24, wherein the organic component corresponds to nanoparticles made from the biopolymer secreted by the microorganism of the formulation, wherein the size of said nanoparticles is in the range of 50-500 nm and wherein the concentration of said nanoparticles is in the between 50-100 mg/L.

26. The composition of claim 23, wherein the formulation protects the plant, crop, fruit, or vegetable where it is applied, for a sustained period of time, including maintaining its protective activity on the given target for at least 6 to 18 months.

27. The composition of claim 23, wherein the formulation protects plants from consecutive freezing and thawing events, for at least 7 consecutive days.


SEQUENCE LISTING (1 sequence)

SEQ ID NO: 1 - DNA, 1532 bp, Artificial Sequence
  GPI-1 (Cepa aislada)
tgaagagtttgatcatggctcagattgaacgctggcggcaggcctaacacatgcaagtcgagcggtagagagaagcttgcttctcttgagagcggcggacgggtgagtaatgcctaggaatctgcctggtagtgggggataacgttcggaaacggacgctaataccgcatacgtcctacgggagaaagcaggggaccttcgggccttgcgctatcagatgagcctaggtcggattagctagttggtggggtaatggctcaccaaggcgacgatccgtaactggtctgagaggatgatcagtcacactggaactgagacacggtccagactcctacgggaggcagcagtggggaatattggacaatgggcgaaagcctgatccagccatgccgcgtgtgtgaagaaggtcttcggattgtaaagcactttaagttgggaggaagggcagtaaattaatactttgctgttttgacgttaccgacagaataagcaccggctaactctgtgccagcagccgcggtaatacagagggtgcaagcgttaatcggaattactgggcgtaaagcgcgcgtaggtggttcgttaagttggatgtgaaatccccgggctcaacctgggaactgcattcaaaactgacgagctagagtatggtagagggtggtggaatttcctgtgtagcggtgaaatgcgtagatataggaaggaacaccagtggcgaaggcgaccacctggactgatactgacactgaggtgcgaaagcgtggggagcaaacaggattagataccctggtagtccacgccgtaaacgatgtcaactagccgttgggagccttgagctcttagtggcgcagctaacgcattaagttgaccgcctggggagtacggccgcaaggttaaaactcaaatgaattgacgggggcccgcacaagcggtggagcatgtggtttaattcgaagcaacgcgaagaaccttaccaggccttgacatccaatgaactttctagagatagattggtgccttcgggaacattgagacaggtgctgcatggctgtcgtcagctcgtgtcgtgagatgttgggttaagtcccgtaacgagcgcaacccttgtccttagttaccagcacgtaatggtgggcactctaaggagactgccggtgacaaaccggaggaaggtggggatgacgtcaagtcatcatggcccttacggcctgggctacacacgtgctacaatggtcggtacagagggttgccaagccgcgaggtggagctaatcccagaaaaccgatcgtagtccggatcgcagtctgcaactcgactgcgtgaagtcggaatcgctagtaatcgcgaatcagaatgtcgcggtgaatacgttcccgggccttgtacacaccgcccgtcacaccatgggagtgggttgcaccagaagtagctagtctaaccttcgggaggacggttaccacggtgtgattcatgactggggtgaagtcgtaacaaggtagccgtaggggaacctgcggctggatcacctcctt